(19) United States
(12) Patent Application Publication
(10) Pub. No.: US 2024/0138958 A1
(43) Pub. Date: May 2, 2024

(54) INDIRECT BONDING TRAY FOR GUM COMPATIBILITY

(71) Applicant: Swift Health Systems Inc., Irvine, CA (US)

(72) Inventors: Todd Oda, Torrance, CA (US); Monica Y. Suh, Irvine, CA (US); Edsel Pereyra, La Puente, CA (US); Scott C. Schwartz, North Babylon, NY (US)

(21) Appl. No.: 18/497,467

(22) Filed: Oct. 30, 2023

Related U.S. Application Data
(60) Provisional application No. 63/381,832, filed on Nov. 1, 2022.
(60) Provisional application No. 63/579,862, filed on Aug. 31, 2023.

(51) Int. Cl. A61C 7/14

(52) U.S. Cl. CPC A61C 7/146

(57) ABSTRACT

An indirect bonding (IDB) tray that can be positioned over a single tooth of a patient. The IDB tray can include a well to receive an orthodontic bracket therein. The IDB tray can be 3D printed with a rigid photopolymer material and a soft photopolymer material. The soft photopolymer material may be disposed on a gingival portion of the IDB tray such that the soft photopolymer material can be positioned proximate the gums of the patient to improve patient comfort and/or accommodate gum remodeling due to tooth movement. The soft photopolymer material may be disposed around an inner periphery of the well to facilitate bracket insertion and/or release from the well. The IDB tray can include separation indicia indicating where the IDB tray can be sectioned. The IDB tray can include long axis lines to indicate proper orientation of the IDB tray on a patient's one or more teeth.

### CROSS REFERENCE TO RELATED APPLICATIONS

This application claims priority to U.S. Provisional Patent Application No. 63/381,832, filed Nov. 1, 2022, and U.S. Provisional Patent Application No. 63/579,862, filed Aug. 31, 2023, which are each incorporated herein by reference in their entireties. Any and all applications for which a foreign or domestic priority claim is identified in the Application Data Sheet of the present application is hereby incorporated by reference under 37 CFR 1.57.

### BACKGROUND

### Field

The present disclosure relates in some aspects to indirect bonding trays such as indirect bonding trays for gum compatibility.

### SUMMARY

Teeth can be moved by bonding orthodontic brackets to the lingual or buccal surfaces of a patient's teeth and coupling an archform to the bonded orthodontic brackets. It can be difficult to position orthodontic brackets on the surfaces of a patient's teeth at positions corresponding to the positions of digital orthodontic brackets on digital teeth in a virtual model of a patient's teeth. Accordingly, indirect bonding (IDB) trays can be used to accurately position orthodontic brackets on a patient's teeth. The IDB tray can be formed (e.g., 3D printed, overmolded on a physical model of a patient's teeth, etc.) based on the virtual model with wells (e.g., pockets, cavities, receptacles) disposed in the IDB tray at positions corresponding to the positions of the digital orthodontic brackets on the digital teeth in the virtual model. The wells of the IDB tray can receive orthodontic brackets. Adhesive can be applied to the orthodontic brackets and the IDB tray can be positioned over the patient's teeth, positioning the orthodontic brackets on the surfaces of the patient's teeth at locations pursuant to the virtual model. The adhesive can be cured, which can be from light, air, heat, etc., bonding the orthodontic brackets to the surfaces of the patient's teeth. An archform can be coupled to the orthodontic brackets and move the teeth toward a planned alignment of the patient's teeth based on the virtual model. The archform may have a custom nonplanar shape. In some instances, a plurality of archforms may be coupled to the orthodontic brackets in series to move the patient's teeth toward the planned alignment. In some instances, an orthodontic bracket may inadvertently de-bond from the surface of a tooth after the archform has moved the patient's teeth partially toward the planned alignment. In some instances, an orthodontic bracket may need to be repositioned after the archform has moved the patient's teeth an amount toward the planned alignment but not to the planned alignment. In some instances, an orthodontic bracket may need to be replaced after the archform has moved the patient's teeth an amount toward the planned alignment but not to the planned alignment.

The IDB tray used to position the orthodontic brackets on the patient's teeth may be unsuited for positioning one or more orthodontic brackets on the patient's teeth after the patient's teeth have started to move because the IDB tray may be based on the maloccluded (e.g., first positions) of the patient's teeth. Furthermore, the IDB tray used to position the orthodontic brackets may not accommodate for gum remodeling (e.g., reconfiguration, changes, etc.) that may have occurred during tooth movement. The IDB tray may also be uncomfortable on the gums of the patient. Additionally, the wells of the IDB tray may have inferior bracket retention and/or release. The IDB trays described herein may at least address the problems detailed above.

Described herein are IDB trays that can be seated on a single tooth to position a single orthodontic bracket on a single tooth of the patient. An IDB tray for a single tooth may advantageously be able to properly position an orthodontic bracket on the tooth of the patient after the patient's teeth have moved because the IDB tray is not dependent on the relative positioning of the patient's teeth. The IDB tray may include a plurality of materials. For example, the IDB tray may include a rigid (e.g., stiff, hard, inflexible) material that may be positioned over the occlusal portions of the tooth (e.g., the crown of the tooth) and a less rigid (e.g., soft, malleable, supple, flexible) material that may be disposed adjacent the gums. The rigid material may allow for better registration with the tooth anatomy. The less rigid material may allow for more flexibility when in contact with the patient's gums, which may increase patient comfort and/or accommodate for gum remodeling (e.g., reconfiguration, changes, etc.) during tooth movement. The less rigid material may line (e.g., coat) the well of the tray to facilitate bracket insertion and/or release from the well. The rigid material may be a rigid photopolymer material. The less rigid material may be a soft photopolymer material. The IDB tray may extend the full crown of the tooth on the labial side to allow for more tooth registration surface. The IDB tray may include information, such as case ID markings to indicate a case ID of a patient, alphanumeric markings to indicate a tooth, and/or other information. The IDB tray may be 3D printed. In some variants, the 3D printer may print multiple materials (e.g., the rigid photopolymer and the soft photopolymer materials). In some variants, the IDB trays may be seated on more than one tooth and position a plurality of orthodontic brackets, such as 2, 3, 4, 5, 6, 7, 8, 9, 10, 11, 12, 13, 14, 15, 16, or more orthodontic brackets. In some variants, the IDB tray may be seated on a segment of the patient's dental arch but include perforations to facilitate sectioning the IDB tray into sections each corresponding to a different tooth of the patient. The perforations may be disposed between adjacent cavities of the IDB tray that receive adjacent teeth of the patient.

In some variants, an indirect bonding (IDB) tray can be seated on a single tooth of a patient to position a single orthodontic bracket on the single tooth is disclosed herein. The IDB tray can include an occlusal portion comprising a first material. The IDB tray can include a gingival portion disposed on and extending gingivally from a gingival end of the occlusal portion. The gingival portion can be disposed proximate gums of the patient and comprising a second material. The IDB tray can include a well that can receive the single orthodontic bracket therein. The IDB tray can be seated on the single tooth of the patient irrespective of a relative positioning of the single tooth with other teeth of the patient.

In some variants, the well can include a periphery that includes the second material.

In some variants, the first material and the second material can be photopolymers.

In some variants, the first material is a rigid photopolymer.

In some variants, the second material is a flexible photopolymer.

In some variants, the first material can include a first color. The second material can include a second color that is different than the first color.

In some variants, the first material and the second material can be transparent (e.g., clear).

In some variants, the IDB tray can include a case identification indicia that can indicate the patient with which the IDB tray corresponds.

In some variants, the case identification indicia can be disposed on an occlusal side of the IDB tray.

In some variants, the case identification indicia can include alphanumeric features.

In some variants, the case identification indicia can include a case identification number.

In some variants, the case identification indicia can be disposed within the IDB tray.

In some variants, the case identification indicia can be disposed on a surface of the IDB tray.

In some variants, the IDB tray can include a tooth identification indicia that can indicate the single tooth with which the IDB tray corresponds.

In some variants, the tooth identification indicia can be disposed on a labial side of the IDB tray.

In some variants, the tooth identification indicia can include alphanumeric features.

In some variants, the tooth identification indicia can be disposed within the IDB tray.

In some variants, the tooth identification indicia can be disposed on a surface of the IDB tray.

In some variants, the IDB tray can include an orientation indicia that may indicate if the IDB tray is properly seated on the single tooth to position the single orthodontic bracket.

In some variants, the orientation indicia can include a line oriented such that a longitudinal length thereof extends in an occlusal-gingival direction.

In some variants, the orientation indicia can be disposed within the IDB tray.

In some variants, the orientation indicia can be disposed on a surface of the IDB tray.

In some variants, the gingival portion may extend from a gingival-most edge of the IDB tray to a position that is 5% of a distance between the gingival-most edge and an occlusal-most point of the IDB tray.

In some variants, the gingival portion may extend from a gingival-most edge of the IDB tray to a position that is 10% of a distance between the gingival-most edge and an occlusal-most point of the IDB tray.

In some variants, the gingival portion may extend from a gingival-most edge of the IDB tray to a position that is 20% of a distance between the gingival-most edge and an occlusal-most point of the IDB tray.

In some variants, the gingival portion may extend from a gingival-most edge of the IDB tray to a position that is 30% of a distance between the gingival-most edge and an occlusal-most point of the IDB tray.

In some variants, the gingival portion may extend from a gingival-most edge of the IDB tray to a position that is 40% of a distance between the gingival-most edge and an occlusal-most point of the IDB tray.

In some variants, an indirect bonding (IDB) tray may be seated on a plurality of teeth of a patient to position a plurality of orthodontic brackets. The IDB tray may include an occlusal portion that can have a first material. The IDB tray may include a gingival portion that may extend gingivally from a gingival end of the occlusal portion. The gingival portion may be disposed proximate gums of the patient and include a second material. The IDB tray may include a plurality of wells that may receive the plurality of orthodontic brackets therein.

In some variants, the plurality of wells may include peripheries that include the second material.

In some variants, the first material and the second material may be photopolymers.

In some variants, the first material may be a rigid photopolymer.

In some variants, the second material may be a flexible photopolymer.

In some variants, the first material may include a first color and the second material may include a second color that is different than the first color.

In some variants, the first material and the second material can be transparent (e.g., clear).

In some variants, the IDB tray may include a case identification indicia that may indicate the patient with which the IDB tray corresponds.

In some variants, the case identification indicia may be disposed on an occlusal side of the IDB tray.

In some variants, the case identification indicia may include alphanumeric features.

In some variants, the case identification indicia may include a case identification number.

In some variants, the case identification indicia may be disposed within the IDB tray.

In some variants, the case identification indicia may be disposed on a surface of the IDB tray.

In some variants, the IDB tray may include a plurality of tooth identification indicias that may indicate the teeth to which the IDB tray corresponds.

In some variants, the plurality of tooth identification indicias may be disposed on labial sides of the IDB tray.

In some variants, the plurality of tooth identification indicias may include alphanumeric features.

In some variants, the plurality of tooth identification indicias may be disposed within the IDB tray.

In some variants, the plurality of tooth identification indicias may be disposed on surfaces of the IDB tray.

In some variants, the IDB tray may include a plurality of orientation indicias that may indicate if the IDB tray is properly seated on the plurality of teeth to position the plurality of orthodontic brackets.

In some variants, the plurality of orientation indicias may include lines oriented such that a longitudinal length of the lines extends in an occlusal-gingival direction.

In some variants, the orientation indicia may be disposed within the IDB tray.

In some variants, the orientation indicia may be disposed on a surface of the IDB tray.

In some variants, the gingival portion may extend from a gingival-most edge of the IDB tray to a position that is 5% of a distance between the gingival-most edge and an occlusal-most point of the IDB tray.

In some variants, the gingival portion may extend from a gingival-most edge of the IDB tray to a position that is 10% of a distance between the gingival-most edge and an occlusal-most point of the IDB tray.

In some variants, the gingival portion may extend from a gingival-most edge of the IDB tray to a position that is 20% of a distance between the gingival-most edge and an occlusal-most point of the IDB tray.

In some variants, the gingival portion may extend from a gingival-most edge of the IDB tray to a position that is 30% of a distance between the gingival-most edge and an occlusal-most point of the IDB tray.

In some variants, the gingival portion may extend from a gingival-most edge of the IDB tray to a position that is 40% of a distance between the gingival-most edge and an occlusal-most point of the IDB tray.

In some variants, a method of forming an indirect bonding (IDB) tray that may be seated on a single tooth of a patient to position a single orthodontic bracket on the single tooth is disclosed herein. The method may include 3D printing the IDB tray. The IDB tray may include an occlusal portion that may include a first material. The IDB tray may include a gingival portion that may extend gingivally from a gingival end of the occlusal portion. The gingival portion may be disposed proximate gums of the patient and may include a second material. The IDB tray may include a well that can receive the single orthodontic bracket therein. The IDB tray may be seated on the single tooth of the patient irrespective of a relative positioning of the single tooth with other teeth of the patient.

In some variants, a method of forming an indirect bonding (IDB) tray that may be seated on a single tooth of a patient to position a single orthodontic bracket on the single tooth is disclosed herein. The method may include scanning an inside of a mouth of the patient. The method may include creating a digital model of the teeth of the patient. The method may include positioning a digital bracket on a single tooth in the digital model. The method may include creating a digital IDB tray with a well positioned and shaped based on the position and shape of the digital bracket on the single tooth in the digital model. The digital IDB tray may include an occlusal portion and a gingival portion that may extend from a gingival end of the occlusal portion. The occlusal portion may be indicated to comprise a first material and the gingival portion may be indicated to comprise a second material. The method may include 3D printing the IDB tray based on the digital IDB tray.

In some variants, 3D printing the IDB tray may include 3D printing with the first material and the second material.

In some variants, the first material and the second material may be photopolymers.

In some variants, the first material may be a rigid photopolymer and the second material may be a flexible photopolymer.

In some variants, the first material may include a first color. The second material may include a second color that is different than the first color.

In some variants, the first material and the second material can be transparent (e.g., clear).

In some variants, creating the digital IDB tray may include adding a case identification indicia that may indicate the patient with which the IDB tray corresponds.

In some variants, the case identification indicia may be disposed on an occlusal side of the IDB tray.

In some variants, the case identification indicia may include alphanumeric features.

In some variants, the case identification indicia may include a case identification number.

In some variants, the case identification indicia may be disposed within the digital IDB tray.

In some variants, the case identification indicia may be disposed on a surface of the digital IDB tray.

In some variants, creating the digital IDB tray may include adding a tooth identification indicia that may indicate the single tooth with which the digital IDB tray corresponds.

In some variants, the tooth identification indicia may be disposed on a labial side of the digital IDB tray.

In some variants, the tooth identification indicia may include alphanumeric features.

In some variants, the tooth identification indicia may be disposed within the digital IDB tray.

In some variants, the tooth identification indicia may be disposed on a surface of the digital IDB tray.

In some variants, creating the digital IDB tray may include adding an orientation indicia that may indicate if the IDB tray is properly seated on the single tooth to position the single orthodontic bracket.

In some variants, the orientation indicia may include a line oriented such that a longitudinal length thereof extends in an occlusal-gingival direction.

In some variants, the orientation indicia may be disposed within the digital IDB tray.

In some variants, the orientation indicia may be disposed on a surface of the digital IDB tray.

In some variants, the gingival portion may extend from a gingival-most edge of the digital IDB tray to a position that is 5% of a distance between the gingival-most edge and an occlusal-most point of the digital IDB tray.

In some variants, the gingival portion may extend from a gingival-most edge of the digital IDB tray to a position that is 10% of a distance between the gingival-most edge and an occlusal-most point of the digital IDB tray.

In some variants, the gingival portion may extend from a gingival-most edge of the digital IDB tray to a position that is 20% of a distance between the gingival-most edge and an occlusal-most point of the digital IDB tray.

In some variants, the gingival portion may extend from a gingival-most edge of the digital IDB tray to a position that is 30% of a distance between the gingival-most edge and an occlusal-most point of the digital IDB tray.

In some variants, the gingival portion may extend from a gingival-most edge of the digital IDB tray to a position that is 40% of a distance between the gingival-most edge and an occlusal-most point of the digital IDB tray.

In some variants, the well may include a periphery that includes the second material.

In some variants, a method of forming an indirect bonding (IDB) tray that can be seated on a plurality of teeth of a patient to position a plurality of orthodontic brackets on the plurality of teeth is disclosed herein. The method can include scanning an inside of a mouth of the patient. The method can include creating a digital model of the teeth of the patient. The method can include positioning a plurality of digital brackets on the plurality of teeth of the digital model. The method can include creating a digital IDB tray with a plurality of wells positioned and shaped based on the position and shape of the digital brackets on the plurality of teeth of the digital model. The digital IDB tray may include an occlusal portion and a gingival portion that may extend gingivally from a gingival end periphery of the occlusal portion. The occlusal portion may be indicated to include a first material and the gingival portion may be indicated to comprise a second material. The method may include 3D printing the IDB tray based on the digital IDB tray.

In some variants, 3D printing the IDB tray may include 3D printing with the first material and the second material.

In some variants, the first material and the second material may be photopolymers.

In some variants, the first material may be a rigid photopolymer and the second material may be a flexible photopolymer.

In some variants, the first material may include a first color. The second material may include a second color that is different than the first color.

In some variants, the first material and the second material can be transparent (e.g., clear).

In some variants, creating the digital IDB tray may include adding a case identification indicia that may indicate the patient with which the IDB tray corresponds.

In some variants, the case identification indicia may be disposed on an occlusal side of the digital IDB tray.

In some variants, the case identification indicia may include alphanumeric features.

In some variants, the case identification indicia may include a case identification number.

In some variants, the case identification indicia may be disposed within the digital IDB tray.

In some variants, the case identification indicia may be disposed on a surface of the digital IDB tray.

In some variants, creating the digital IDB tray may include adding a plurality of tooth identification indicias that may indicate the plurality of teeth to which the digital IDB tray corresponds.

In some variants, the plurality of tooth identification indicias may be disposed on labial sides of the digital IDB tray.

In some variants, the tooth identification indicia may include alphanumeric features.

In some variants, the plurality of tooth identification indicias may be disposed within the digital IDB tray.

In some variants, the plurality of tooth identification indicias may be disposed on surfaces of the digital IDB tray.

In some variants, creating the digital IDB tray may include adding a plurality of orientation indicias that may indicate if the IDB tray is properly seated on the plurality of teeth to position the plurality of orthodontic brackets.

In some variants, the plurality of orientation indicias may include lines oriented such that longitudinal lengths thereof extend in an occlusal-gingival direction.

In some variants, the plurality of orientation indicias may be disposed within the digital IDB tray.

In some variants, the plurality of orientation indicias may be disposed on surfaces of the digital IDB tray.

In some variants, the gingival portion may extend from a gingival-most edge of the digital IDB tray to a position that is 5% of a distance between the gingival-most edge and an occlusal-most point of the digital IDB tray.

In some variants, the gingival portion may extend from a gingival-most edge of the digital IDB tray to a position that is 10% of a distance between the gingival-most edge and an occlusal-most point of the digital IDB tray.

In some variants, the gingival portion may extend from a gingival-most edge of the digital IDB tray to a position that is 20% of a distance between the gingival-most edge and an occlusal-most point of the digital IDB tray.

In some variants, the gingival portion may extend from a gingival-most edge of the digital IDB tray to a position that is 30% of a distance between the gingival-most edge and an occlusal-most point of the digital IDB tray.

In some variants, the gingival portion may extend from a gingival-most edge of the digital IDB tray to a position that is 40% of a distance between the gingival-most edge and an occlusal-most point of the digital IDB tray.

In some variants, the well may include a periphery that includes the second material.

In some variants, an indirect bonding (IDB) tray that may be seated on a single tooth of a patient to position an orthodontic bracket on the single tooth is disclosed herein. The IDB tray may include an occlusal portion that may include a first material. The IDB tray may include a gingival portion that may extend gingivally from a gingival end periphery of the occlusal portion. The gingival portion may be disposed proximate gums of the patient and may include a second material. The IDB tray may include a well that may receive the orthodontic bracket therein. The IDB tray may be seated on the single tooth of the patient irrespective of a relative positioning of the single tooth with other teeth of the patient.

In some variants, the first material may be more rigid than the second material.

In some variants, the first material may include a tensile strength that is greater than a tensile strength of the second material.

In some variants, the first material may include a tensile strength of 50-65 MPa.

In some variants, the second material may include a tensile strength of 3-5 MPa.

In some variants, the first material may be less flexible than the second material.

In some variants, the first material may include a percent elongation that is less than a percent elongation of the second material.

In some variants, the first material may include a percent elongation of 10-25%.

In some variants, the second material may include a percent elongation of 45-55%.

In some variants, the first material may include a hardness that is greater than a hardness of the second material.

In some variants, the first material may include a Shore D hardness of 83-86.

In some variants, the second material may include a Shore A hardness of 73-77.

Described herein are IDB trays with markings and/or perforations defining areas where a portion of the IDB tray can be cut or otherwise separated (e.g., torn) from the remainder of the IDB tray. The portion of the IDB tray can be seated on a single tooth or multiple teeth (e.g., 2, 3, 4, 5, 6, 7, 8, 9, 10, 11, 12, 13, 14, or 15) to position one or more orthodontic brackets, auxiliaries (e.g., button, hook, etc.), bite turbos, etc. on one or more teeth of the patient. An IDB tray configured to aid an operator in cutting or otherwise sectioning the IDB tray into a portion to be seated on a single tooth or a plurality of teeth along a dental arch may advantageously enable positioning the portion of the IDB tray containing an orthodontic bracket, auxiliary, bite turbo, etc. on one or more teeth of the patient without needing to position another portion of the IDB tray along the dental arch of the patient. The IDB tray can be cut or otherwise separated into portions that can be made of materials similar to other IDB trays disclosed herein. The IDB tray may extend the full crown of the tooth on the labial side to allow for more tooth registration surface. The IDB tray may include information, such as case ID markings to indicate a case ID of a patient, alphanumeric markings to indicate a tooth, cut or perforation lines to indicate where the IDB tray should be sectioned and/or other information. The IDB tray may be 3D printed. In some variants, the 3D printer may print multiple materials (e.g., a rigid photopolymer and a soft photopolymer). In some variants, the IDB trays may be seated on more than one tooth and position a plurality of orthodontic brackets, such as 2, 3, 4, 5, 6, 7, 8, 9, 10, 11, 12, 13, 14, 15, 16, or more orthodontic brackets.

In some aspects, the techniques described herein relate to an indirect bonding tray (IDB) tray configured to be separable into portions, the IDB tray including: a plurality of cavities, each configured receive a tooth of a patient with the IDB tray seated on a patient's dental arch; a well configured to receive an orthodontic bracket therein; and a plurality of separation indicia, each of the plurality of separation indicia disposed between adjacent cavities of the plurality of cavities and indicating where to separate the IDB tray; wherein the IDB tray is configured to be separated at one or more of the plurality of separation indicia to form separate IDB tray portions.

In some variants, the techniques described herein relate to an IDB tray, wherein at least one of the IDB tray portions is configured to be seated on only a single tooth.

In some variants, the techniques described herein relate to an IDB tray, wherein at least one of the IDB tray portions is configured to be seated on only two teeth.

In some variants, the techniques described herein relate to an IDB tray, wherein at least one of the IDB tray portions is configured to be seated on only three teeth.

In some variants, the techniques described herein relate to an IDB tray, wherein at least one of the IDB tray portions is configured to be seated on four or more teeth.

In some variants, the techniques described herein relate to an IDB tray, further including: an occlusal portion including a first material; and a gingival portion disposed extending gingivally from a gingival end periphery of the occlusal portion, the gingival portion configured to be disposed proximate gums of the patient and including a second material.

In some variants, the techniques described herein relate to an IDB tray, wherein the first material and the second material include different colors.

In some variants, the techniques described herein relate to an IDB tray, wherein the plurality of separation indicia include lines on an outer surface of the IDB tray.

In some variants, the techniques described herein relate to an IDB tray, wherein the plurality of separation indicia include lines printed along an innermost surface of the IDB tray.

In some variants, the techniques described herein relate to an IDB tray, wherein the plurality of separation indicia are printed along an occlusal surface of the IDB tray.

In some variants, the techniques described herein relate to an IDB tray, wherein the plurality of separation indicia are printed along a buccal surface of the IDB tray.

In some variants, the techniques described herein relate to an IDB tray, wherein the plurality of separation indicia are printed along a lingual surface of the IDB tray.

In some variants, the techniques described herein relate to an IDB tray, wherein the plurality of separation indicia are colored distinctly from the IDB tray.

In some variants, the techniques described herein relate to an IDB tray, wherein the plurality of separation indicia are printed below an outermost surface of the IDB tray.

In some variants, the techniques described herein relate to an IDB tray, wherein the plurality of separation indicia include perforations to facilitate separating the IDB tray.

In some variants, the techniques described herein relate to an IDB tray, wherein the plurality of separation indicia include voids.

In some variants, the techniques described herein relate to an IDB tray, wherein the voids are formed by not printing material in certain positions.

In some variants, the techniques described herein relate to an IDB tray, wherein the voids are formed by cutting into the IDB tray.

In some variants, the techniques described herein relate to an IDB tray, wherein the voids are formed by heating an element and melting the voids into the IDB tray.

In some variants, the techniques described herein relate to an IDB tray, wherein the voids are distributed along the separation indicia.

In some variants, the techniques described herein relate to an IDB tray, wherein the plurality of separation indicia include snap indicia.

In some variants, the techniques described herein relate to an IDB tray, wherein the snap indicia include rigid materials.

In some variants, the techniques described herein relate to an TDB tray, wherein the snap indicia include a feature to facilitate snapping of the IDB tray to form the IDB tray portions.

In some variants, the techniques described herein relate to an IDB tray, wherein the feature is a snap divot.

In some variants, the techniques described herein relate to an IDB tray, wherein the feature is an area with thinner material compared to adjoining areas.

In some variants, the techniques described herein relate to an IDB tray, wherein the snap indicia include rigid materials.

In some variants, the techniques described herein relate to an IDB tray, wherein the snap indicia is rigidly attached to the IDB tray.

In some variants, the techniques described herein relate to an IDB tray, further including orientation indicia configured to visually indicate to a user if the IDB tray is properly seated on the patient's dental arch.

In some variants, the techniques described herein relate to an IDB tray, wherein the orientation indicia include lines.

In some variants, the techniques described herein relate to an IDB tray, wherein the lines are disposed on the IDB tray at locations of the plurality of cavities.

In some variants, the techniques described herein relate to an IDB tray, wherein the lines are centered on the plurality of cavities in a mesial-distal direction.

In some variants, the techniques described herein relate to an IDB tray, wherein the lines extend from a lingual side of the IDB tray to a buccal side.

In some variants, the techniques described herein relate to an IDB tray, wherein the lines extend in a gingival-occlusal direction.

In some variants, the techniques described herein relate to an IDB tray, wherein the lines are disposed between adjacent separation indicia of the plurality of separation indicia.

In some variants, the techniques described herein relate to an IDB tray, further including an occlusal portion including a first material and a gingival portion extending gingivally from a gingival end periphery of the occlusal portion, the gingival portion configured to be disposed proximate gums of the patient and including a second material.

In some variants, the techniques described herein relate to an IDB tray, wherein the first material includes a first hardness and the second material includes a second hardness.

In some variants, the techniques described herein relate to an IDB tray, wherein the first hardness is greater than the second hardness.

In some variants, the techniques described herein relate to an IDB tray, further including indicia to visually associate the IDB tray portions with portions of the patient's dental arch.

In some variants, the techniques described herein relate to an IDB tray, further including patient identification indicia.

In some variants, the techniques described herein relate to an IDB tray, wherein the lines are long axis lines.

In some variants, the techniques described herein relate to an IDB tray, wherein the lines correspond to long axes of the patient's teeth.

In some variants, the techniques described herein relate to an IDB tray, wherein the lines are configured to indicate an alignment of the IDB tray relative to long axes of the patient's teeth.

In some variants, the IDB trays described herein can include a plurality of separation indicia indicating where to separate the IDB tray. In some variants, the IDB trays described herein can include one or more separation indicia indicating where to separate the IDB tray.

In some variants, creating the digital IDB tray can include adding one or more separation indicia indicating where to separate the IDB tray.

### BRIEF DESCRIPTION OF THE DRAWINGS

These drawings are illustrative embodiments and do not present all possible embodiments of this invention. The illustrated embodiments are intended to illustrate, but not to limit, the scope of protection. Various features of the different disclosed embodiments can be combined to form further embodiments, which are part of this disclosure.

FIG. 1 illustrates an archform.

FIG. 2 illustrate the archform in a custom nonplanar shape.

FIG. 3 illustrates a connector of the archform.

FIG. 4 illustrates an orthodontic bracket.

FIG. 5 illustrates the connector of FIG. 3 coupled with the orthodontic bracket of FIG. 4.

FIG. 6 illustrates a plurality of indirect bonding (IDB) trays.

FIGS. 7A and 7B illustrate different views of a single tooth IDB tray.

FIGS. 8A and 8B illustrate different views of a single tooth IDB tray.

FIGS. 9A and 9B illustrate different views of a single tooth IDB tray.

FIG. 10 illustrates a labial auxiliary applicant.

FIG. 11 illustrates a method of forming an IDB tray.

FIG. 12 illustrates an IDB tray with a plurality of separation indicia and alignment indicia.

FIG. 13A illustrates an IDB tray separated into portions-one portion for a single tooth and another portion for a plurality of teeth.

FIG. 13B illustrates an IDB tray separated into portions-one portion for a plurality of teeth and another portion for another plurality of teeth.

FIG. 14 illustrates an IDB tray with a plurality of snap indicia and alignment indicia.

### DETAILED DESCRIPTION

Malocclusion of the teeth may be treated using orthodontic brackets and archforms to move the patient's teeth using sliding or non-sliding mechanics, as described in U.S. patent application Ser. No. 17/303,860, filed Jun. 9, 2021, now published as U.S. Publication No. 2021/0401548, the entirety of which is hereby incorporated by reference herein. Scans of a patient's teeth can be taken and a digital model (e.g., virtual model) of the patient's teeth can be created, at least in part, from the scans. The teeth of the digital model can be moved from positions of malocclusion (e.g., first positions) to second positions, which may be a planned alignment of the teeth such as a final planned alignment of the teeth.

Digital brackets can be placed, respectively, on the lingual or buccal surfaces of the teeth in the digital model. In some variants, the digital brackets can be placed before moving the teeth of the digital model from the positions of malocclusion (e.g., first positions) to the second positions (e.g., planned alignment). The positions of the digital brackets on the teeth of the digital model in the second positions can correspond to a custom shape of an archform that can move the patient's teeth from the first positions of malocclusion to the second positions. For example, digital markers can be positioned on and/or in the digital brackets to indicate positions for the connectors of the archform with the archform in a custom 3D shape that can move the patient's teeth to the second positions. In some variants, the digital brackets may include features to indicate placement of the digital markers. In some variants, a software program may automatically place the digital markers on and/or in the digital brackets. In some variants, the digital brackets may include digital markers. In some variants, no digital brackets are used and the positions of the teeth in the digital model can correspond to a custom shape of an archform that can move the patient's teeth from the first positions to the second positions. For example, the digital markers can be positioned on and/or proximate the digital teeth in the digital model without digital brackets.

A system can include a plurality of arms and a robot that can custom 3D shape an archform based on the digital model. For example, the robot can indicate a position for each of the plurality of arms in space that corresponds to a position of a digital marker disposed on and/or in a digital bracket in the digital model. As described herein, each digital marker can correspond to a connector of the archform. An operator can move each of the plurality of arms to a position indicated by the robot. The operator can couple the archform to each of the plurality of arms such that the archform assumes a custom 3D shape corresponding to the positions of the digital markers. In some variants, the plurality of arms can automatically move to positions indicated by the robot. In some variants, the robot can couple the archform to each of the plurality of arms. In some variants, the plurality of arms can automatically move to positions corresponding to the positions of the digital markers in the digital model with the teeth in the second positions without the robot indicating the positions. In some variants, the system can be used to custom 3D shape an archform based on the positioning of digital markers on digital teeth in the digital model without digital brackets. In some variants, a digital archform can be designed in the digital model with the teeth of the digital model in the second positions and the system can custom shape the archform based on the digital archform. In some variants, the system and/or digital model can compensate for material characteristics of the archform. For example, the forces exerted by the archform to move the patient's teeth toward the second positions may decrease as the patient's teeth get closer to the second positions to the extent that, if not taken into account, the archform may be unable to completely move the patient's teeth to the second positions. Accordingly, the archform can be custom 3D shaped to compensate for these decreasing forces. For example, absent the reactionary forces of the patient's teeth in the second positions, connectors of the custom-shaped archform may be positioned beyond the positions of the corresponding digital markers, digital brackets, and/or digital teeth of the digital model in the planned alignment to compensate for the decreasing forces.

The archform, which may also be referred to as an archwire, can be made of a shape memory material, such as a shape memory alloy (e.g., nickel-titanium alloy such as Nitinol) and/or a shape memory polymer. The archform can be cut (e.g., laser, waterjet, plasma cut, punching, etc.) from a sheet of material (e.g., shape memory material). In some variants, the archform can be bent with a wire bender from a wire of material (e.g., shape memory material). The archform can include connectors (e.g., bracket connectors, anchors) that can be coupled to brackets or bonded directly to teeth and interproximal segments (e.g., interproximal loops) that can be disposed between connectors and can move one or more teeth of the patient. When cut from the sheet of material, the archform can have a substantially flat two-dimensional shape and/or otherwise planar shape. When the wire is bent with the wire bender, the archform can have a substantially flat two-dimensional shape and/or otherwise planar shape. The archform can be deflected from the two-dimensional shape and coupled to the holders of the plurality of arms of the system to assume the custom nonplanar shape. For example, the connectors of the archform can be coupled to the holders of the plurality of arms such that the connectors are in positions corresponding to the positions of the digital markers in the digital model of the patient's teeth in the second positions.

While retained in the custom nonplanar shape by the holders of the plurality of arms, the archform can be heat set. The setting of the archform can be accomplished by way of exposure to heat with a heating element, which can at least be accomplished with an oven, furnace, heat gun, and/or other suitable devices. For example, the robot can apply heat to the archform with a heating element, such as a heat gun. In some variants, electrical current can be applied to the archform to set the archform in the custom shape. Setting the archform can set a new default or memorized shape (e.g., configuration) for the archform such that the archform is biased toward the default or memorized shape when deflected therefrom. Accordingly, if the archform is deflected from the memorized custom nonplanar shape, the archform can exert forces to return the archform back to the memorized custom nonplanar shape. The archform can also be heat treated to set a transition temperature such that the archform is pliable at room temperature but rigid at and/or near body temperature. For example, the archform in the custom nonplanar shape can have a transformation temperature set such that the material is in the martensite phase when the temperature of the archform is between 65 and 75 degrees Fahrenheit, which can correspond with room temperature, and austenite phase when the temperature of the archform is between 97 and 99 degrees Fahrenheit, which can correspond with body temperature. This can enable an archform to be in the martensite phase and pliable as the archform is installed in a patient's mouth (e.g., coupled to brackets disposed on the patient's teeth), but once the patient's mouth warms the archform above the transformation temperature, the archform can be in the austenite phase and activate, e.g., spring, toward the memorized custom nonplanar shape, which can move the patient's teeth toward an alignment (e.g., the second positions, which can be a final alignment).

An indirect bonding (IDB) tray can be formed based on the digital model. The teeth of the digital model, with the digital brackets disposed thereon, can be returned back to the positions of malocclusion that can reflect the current positions of the patient's teeth. In some variants, the IDB tray can be formed based on the digital model with digital brackets placed on the maloccluded teeth of the digital model prior to movement of the teeth to the second positions. An IDB tray can be 3D printed based on the digital model and/or over molded on a physical model of the patient's teeth. The IDB tray can be sized and shaped to fit over one tooth of the patient, a segment of the dental arch of the patient, and/or an entire dental arch of the patient. The IDB tray can include one or more wells (e.g., pockets, recesses, etc.) that can house orthodontic brackets therein. For example, each cavity of the IDB tray that can receive a patient's tooth can have a corresponding well. The wells can be positioned based on the corresponding positioning of the digital brackets in the digital model.

Orthodontic brackets can be placed in respective wells of the IDB tray with contact surfaces (e.g., bonding surfaces) exposed. An adhesive can be applied to the contact surfaces and the loaded IDB tray can be placed over the teeth of the patient, positioning the orthodontic brackets at locations on the teeth of the patient that correspond to the positioning of the digital brackets on the teeth in the digital model in the first positions. The orthodontic brackets can be bonded to the teeth of the patient, which can be facilitated by exposing the adhesive to air, light (e.g., UV light), heat, low temperatures, and/or chemical(s).

With the orthodontic brackets bonded to the teeth of the patient, the custom shaped archform can be deflected from the custom 3D shape and coupled to the bonded orthodontic brackets. The connectors of the archform can be coupled, e.g., locked, to the bonded orthodontic brackets such that the archform does not slide with respect to the brackets. As described herein, the deflected archform can exert forces on the teeth of the patient as the archform exerts forces to move back toward the undeflected position (e.g., memorized custom nonplanar shape), which can move the teeth of the patient, using non-sliding mechanics, toward seconds positions that correspond to the second positions of the teeth in the digital model (e.g., planned alignment of the teeth). In some variants, the archform can be deflected from the custom nonplanar shape and bonded directly to the patient's teeth, including buccal or lingual surfaces.

In some variants, a series of archforms can be sequentially installed in the patient's mouth (e.g., coupled to the brackets) and replaced to move the patient's teeth from positions of malocclusion to the second positions. For example, an initial archform set in the custom nonplanar shape may be used for an initial stage of treatment for initially moving the teeth of the patient toward the second positions. An intermediate archform set in the custom nonplanar shape, which may be stiffer than the initial archform, may be used for an intermediate stage of treatment for moving the teeth of the patient closer toward the second positions. A final archform set in the custom nonplanar shape, which may be stiffer than the intermediate archform, may be used for a final stage of treatment for moving the teeth of the patient closer toward or to the second positions. In some variants, the interproximal segments, which can include interproximal loops, can be increasingly stiffer with each successive archform (e.g., the interproximal segments of the intermediate archform are stiffer than those of the initial archform). In some variants, one archform is used in a treatment plan instead of multiple. In some variants, two, three, four, five, or more archforms may be used for each arch (e.g., upper and lower arches) in a treatment plan. Malocclusion of the teeth may be treated using one or more archforms to move the patient's teeth using non-sliding and/or sliding mechanics.

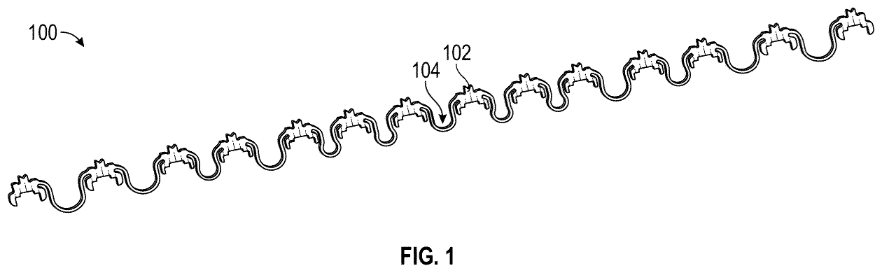

FIG. 1 illustrates an example embodiment of an archform 100, which can also be referred to as an archwire. The illustrated embodiment of the archform 100 along with other embodiments of the archform are described in U.S. patent application Ser. No. 17/303,860, filed Jun. 9, 2021, now published as U.S. Publication No. 2021/0401548, the entirety of which is hereby incorporated by reference herein. The archform 100 can have a polygonal (e.g., rectangular, square), circular, oval, irregular, and/or other shaped cross-section. The archform 100, as described herein, can be cut (e.g., laser, waterjet, punching, etc.) from a sheet of material, such as shape memory material, which can include shape memory alloys (e.g., nickel titanium such as Nitinol) and/or shape memory polymers. The archform 100, as illustrated in FIG. 1, has a planar (e.g., flat) shape. The archform 100 can correspond to a segment of an upper or lower dental arch of a patient. The archform 100 can correspond to an entirety of an upper or lower dental arch of a patient.

The archform 100 can include a plurality of connectors or connector portions 102 (e.g., bracket connectors, anchors) that can be coupled to orthodontic brackets to install the archform 100 in the mouth of a patient and/or be directly bonded to a patient's teeth without an orthodontic bracket. The archform 100 can include a plurality of interproximal segments 104. The interproximal segments 104 can be disposed between adjacent connectors 104. The interproximal segments 104 can correspond to interdental spaces between adjacent teeth of the patient. The interproximal segment 104 can include loops. The loops can extend in a gingival direction when the archform 100 is installed in the mouth, which can improve aesthetics and/or facilitate flossing. The loops can open to move adjacent teeth apart from each other. The loops can close to move adjacent teeth closer together. The loops can be various shapes, including U, T, tear-drop, triangular, rectangular, boot, and/or others. The loops of the archform 100 can have varying rigidity. For example, the forces to move molars may be greater than other teeth; accordingly, the loops adjacent the molars may be more rigid than loops not adjacent molars. The rigidity can vary due to the curvature of the loop, shape of the loop, size of the loop, and/or width. In some variants, the loops of the intermediate archform may be more rigid than corresponding loops of the initial archform, and the loops of the final archform may be more rigid than the corresponding loops of the intermediate archform. The loops can extend (e.g., curve) gingivally down from one connector 102 to an intermediate position and back up occlusally to another adjacent connector 102 such that the loop is open in an occlusal direction, which may be beneficial for flossing.

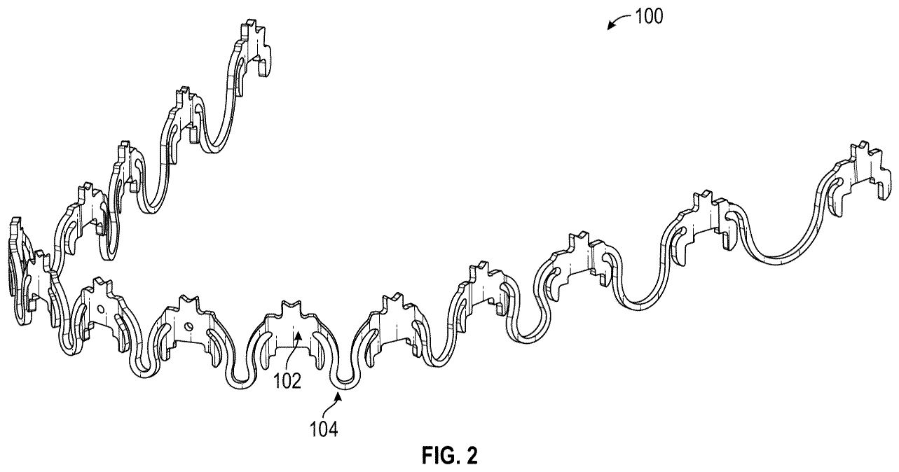

FIG. 2 illustrates the archform 100 in a custom non-planar shape (e.g., custom 3D shape, custom memorized shape, custom memorized 3D shape). The custom non-planar shape can correspond to a planned alignment of a patient's teeth. As described herein, the archform 100 may correspond to a segment or the entirety of a patient's upper or lower dental arch. As illustrated in FIG. 2, the archform 100 has an arch shape.

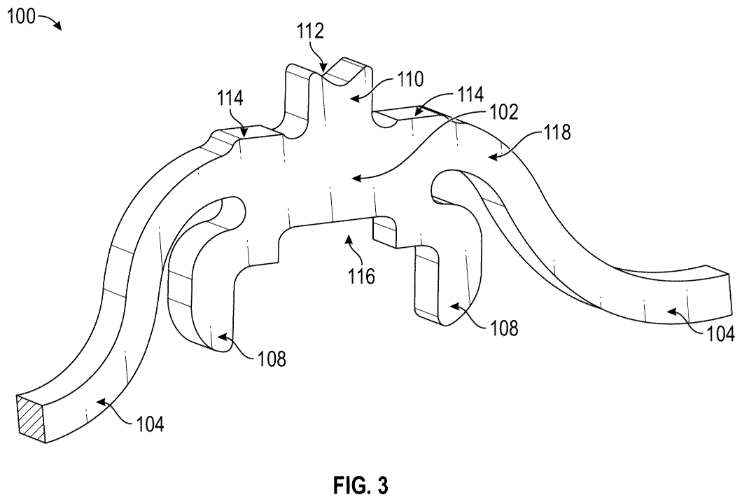

FIG. 3 illustrates the connector 102 (e.g., bracket connector, anchor, male fastener, connector portion) of an archform 100. The connector 102 can be coupled to an orthodontic bracket such that the connector 102 does not slide with respect to the orthodontic bracket. In some variants, the connector 102 can be directly coupled (e.g., bonded, adhered) to the tooth of a patient. The connector 102 can be oriented in different orientations to move a tooth of a patient. The connector 102 can be disposed between interproximal segments 104. The interproximal segments 104, as described herein, can apply forces to adjacent connector(s) 102 to move teeth of a patient.

The connector 102 can have arms 108. The arms 108 can extend in a direction that is opposite that of a tab 110 (e.g., tongue) of the connector 102. The arms 108 can extend in at least an occlusal or gingival direction. The arms 108 can grip one or more features of an orthodontic bracket to help secure the connector 102 and/or provide improved control of a tooth of the patient. The arms 108 can grip a retainer of the orthodontic bracket. For example, the arms 108 can grip, hold, grasp, hug, snap around, and/or otherwise interface with the mesial and distal sides of the retainer. In some variants, the arms 108 can hold the archform 100 (e.g., connector 102) in place on the bracket as an operator positions a tool to secure the connector 102 to the bracket. The arms 108 can include outer sides that are curved, which can help the arms 108 to better grip the retainer of the bracket.

A recess 116, also referred to as a gap, can be disposed between the arms 108. The recess 116 can receive a C spring of the orthodontic bracket and/or other feature when the connector 102 is locked into a slot of the orthodontic bracket. The periphery defining at least a portion of the recess 116 can contact the C spring. The C spring can apply a force against the periphery of the recess 116 to push the connector 102 against stops of the bracket which can position a portion of the connector 102 under overhangs of the stops. The connector 102 can include contact surfaces 114 which can contact the stops of the orthodontic bracket. The contact surfaces 114 can be flat to provide a secure point of contact with the stops of the orthodontic bracket. The stops of the orthodontic bracket can have corresponding flat surfaces. The contact surfaces 114 can be disposed on a side of the connector 102 that is opposite the arms 108 and/or recess 116. The contact surfaces 114 can be disposed on opposing sides of the tab 110.

The tab 110 can be disposed on a side of the connector 110 that is opposite the arms 108 and/or recess 116. The tab 110 can be disposed in a gap between stops of the orthodontic bracket when the connector 102 is disposed in the slot of the orthodontic bracket. The tab 110 can contact inner sides of the stops, which can help to prevent sliding of the connector 102 in a mesial-distal direction relative to the orthodontic bracket. The tab 110 can extend in a gingival or occlusal direction. The tab 110 can include a groove 112. The groove 112 can be disposed on an end of the tab 110. The groove 112 can receive a tool to facilitate positioning the connector 102 into the slot of the orthodontic bracket or removing the connector 102 therefrom. The groove 112 can help to prevent inadvertent sliding of the tool being used to place the connector 102 into the slot of the orthodontic bracket. The connector 102 can include curves to reduce stress concentrators.

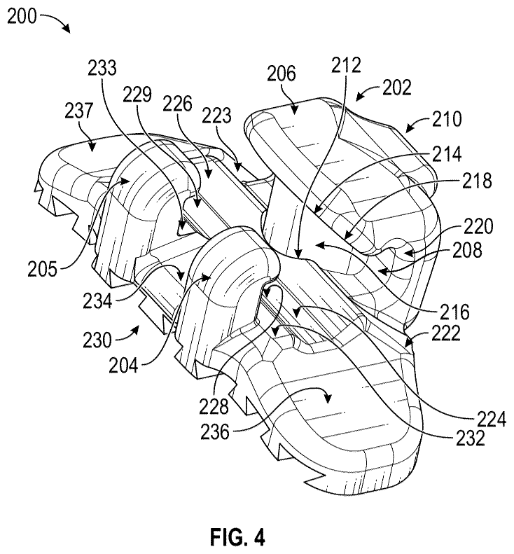

FIG. 4 illustrates an orthodontic bracket 200. The bracket 200 can be disposed on the lingual or buccal side of a patient's teeth. The bracket 200 can couple with the connector 102 of the archform 100 to facilitate moving a patient's teeth using non-sliding mechanics. In some variants, the bracket 200 can have utility when used with archforms of different configurations than those described herein. The bracket 200 can include a slot 208, also referred to as a receiving region or receiving space, that can receive the connector 102 of the archform 100 therein such that the connector 102 is prevented from sliding relative to the bracket 200 when installed in a patient's mouth. The slot 208 can be positioned between a retainer 202 and stops 204, 205. The slot 208 can be at least partially defined between the retainer 202, stops 204, 205, and a face 224 of the bracket 200.

As described herein, the retainer 202 can help to retain the connector 102 within the slot 208. The retainer 202 can at least be positioned proximate or at a gingival or occlusal side of the bracket 200. The retainer 202 can extend from the face 224 of the bracket 200. The retainer 202 can include one or more features to improve handling the bracket 200. For example, the retainer 202 can have a protuberance 210, also referred to as a bump, protrusion, or engagement region, that can be gripped by a tool during handling of the bracket 200. The protuberance 210 can extend in a gingival or occlusal direction.

The retainer 202 can include one or more features to improve retention of the connector 102 received in the slot 208 of the bracket 200. For example, the retainer 202 can include an overhang 206, e.g., extension. The overhang 206 can help hold the connector 102 within the slot 208. The overhang 206 can be offset from the face 224. The overhang 206 can extend over the slot 208 and/or face 224. The overhang 206 can include a curved portion 214 that extends over the slot 208 and/or face 224 of the bracket 200. The retainer 202 and/or overhang 206 can include an angled surface 218 that can facilitate the connector 102 being positioned within the slot 208 of the bracket 200 at an angle before being rotated toward the face 224 of the bracket 200 and being locked within the bracket 200, such as in the slot 208. The retainer 202 can include a recess 220, also referred to as a gap, undercut, cutout, space, etc., that can facilitate the connector 102 being rotated in and out of the slot 208 of the bracket 200 as detailed herein.

The bracket 200 can include a spring 216 (e.g., lock spring) that can facilitate locking the connector 102 of the archform 100 within the bracket 200. The spring 216 can be a compressible material with resilient properties that can be biased to a certain position. The spring 216 can be a C spring, rounded spring, leaf spring, etc. The spring 216 can be housed within an opening 212. The opening 212 can be disposed through at least a portion of the retainer 202. The C spring 216 can be inserted into the opening 212 by way of a face of the bracket 200 that is opposite the face 224. The C spring 216 can be exposed to the slot 208 such that the connector 102 can contact the C spring 216 when positioned within the slot 208. The C spring 216 can be oriented with a longitudinal axis thereof oriented perpendicularly relative to the plane of the face 224. The opening 212 can be contoured and/or shaped to prevent titling and/or rattling of the C spring 216 within the opening 212. The opening 212 can be bounded by a periphery that can help to prevent the C spring 216 from deflecting beyond a desired range (e.g., beyond elastic deformation). With the connector 102 of the archform 100 in the bracket 200, the C spring 216 can apply a force to the connector 102 that pushes the connector 102 against and/or at least partially under the stops 204, 205 such that the connector 102 is locked within the slot 202 of the bracket 200.

The stops 204, 205 can be proximate an opposite end of the bracket 200 relative to the retainer 202. In some variants, the stops 204, 205 can be in a mirrored configuration about a central plane of the bracket 200. The stops 204, 205 can include receiving spaces 228, 229, respectively. The receiving spaces 228, 229 can be at least partially bounded by extensions (e.g., overhangs) of the stops 204, 205. The receiving spaces 228, 229, which can also be referred to as pockets or cutouts, can receive, respectively, a portion of the connector 102 therein to secure the connector 102 within the slot 208. In some variants, the bracket 200 can include two stops 204, 205. In some variants, the bracket 200 may include one, three, four or more stops that can help retain the connector 102 of the archform 100 within the bracket 200. The stops 204, 205 can be spaced apart from each other, which can be in the mesial-distal direction. A gap 234 can separate the stops 204, 205. The gap 234 can receive the tab 110 of the connector 102, as described herein. The portion of the face 224 spanning the gap 234 can be at least flat, angled, or curved. The portion of the face 224 spanning the gap 234 can be angled relative to other portions of the face 224 and/or curved at an end of the bracket 200.

The bracket 200 can include ramps 232, 233. The ramps 232, 233 can also be referred to as inclined surfaces, protrusions, angled surfaces, wedges, bumps, etc. The ramps 392, 393 can extend away from the face 224 of the bracket 200. The ramps 232, 233 can push the connector 102 against the stops 204, 205 to help secure the connector 102 within the slot 208. The ramps 232, 233 can push the connector 102 against the overhangs of the stops 204, 205. The ramps 232, 233 can include a flat surface that can engage the connector 102 when the connector 102 is secured within the slot 208. In some variants, the ramps 232, 233 can extend beyond a width of the stops 204, 205, respectively, which can help improve rotational control of a tooth.

The bracket 200 can include a protrusion 226 (e.g., bump). The protrusion 226 can extend from the face 224. The protrusion 226 can apply a force against the connector 102, when positioned within the slot 208, to push the connector 102 against the stops 204, 205 and/or overhang 206 of the retainer 202 to help secure the connector 102. The protrusion 226 can extend laterally beyond a width of the retainer 202, which can help improve rotational control of a tooth. The protrusion 226 can extend laterally beyond the stops 204, 205. In some variants, the opening 212 can disrupt a portion of the protrusion 226.

The bracket 200 can include inclined surfaces 222, 223 that can facilitate inserting a connector 102 within the slot 208 of the bracket 200 before rotating the connector 102 toward the face 224 of the bracket 200 to lock the connector 102 into place. The inclined surfaces 222, 223 can be positioned on opposing sides of the retainer 202.

The bracket 200 can include lateral extensions 236, 237, which can also be referred to as lateral wings. The lateral extensions 236, 237 can help the bracket 200 to better control movement of a molar or other tooth. For example, the lateral extensions 236, 237 can facilitate better rotational control. The lateral extensions 236, 237 can also provide more surface area for a textured surface 230 for improved bonding.

The bracket 200 can include a textured surface 230, also referred to as a surface with undercuts, cuts, gaps, voids, and/or slots. The textured surface 230 can be disposed on a side of the bracket 200 that is opposite the face 224. The textured surface 230 can facilitate bonding the bracket 200 to a surface of the patient's teeth. Specifically, an adhesive applied to the textured surface 230 can bond the textured surface 230 to the surface of the patient's tooth. The textured surface 230 can provide an increased surface area to facilitate improved bonding compared to an un-textured surface.

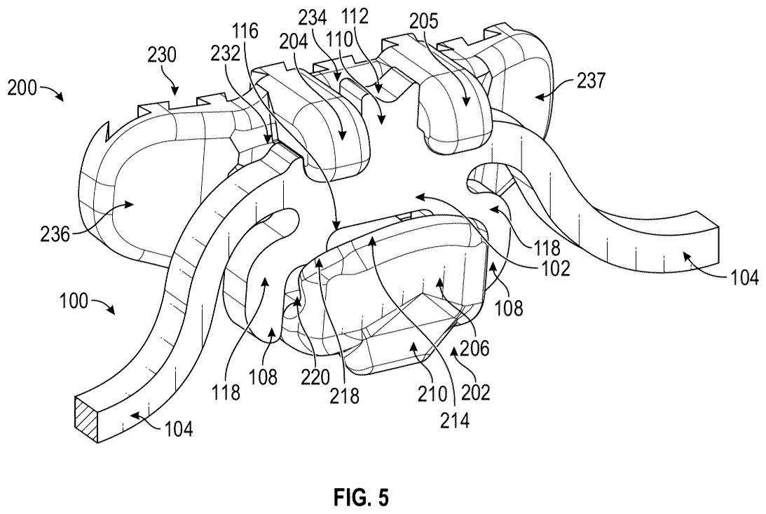

FIG. 5 illustrates the connector 102 coupled to the bracket 200. As illustrated, the connector 102 is disposed in the slot 208 of the bracket 200. The C spring 216 can push the connector 102 against the stops 204, 205 and/or under at least a portion of the stops 204, 205. The contact surfaces 114 can contact the stops 204, 205. The force applied by the C spring 216 can lock the connector 102 under the overhangs of the stops 204, 205 and the overhang 206 of the retainer 202.

The bracket 200 and/or connector 102 of the archform 100 can include modifications to accommodate the various teeth of the patient, such as the molars, bicuspids, lower anterior, and upper central teeth.

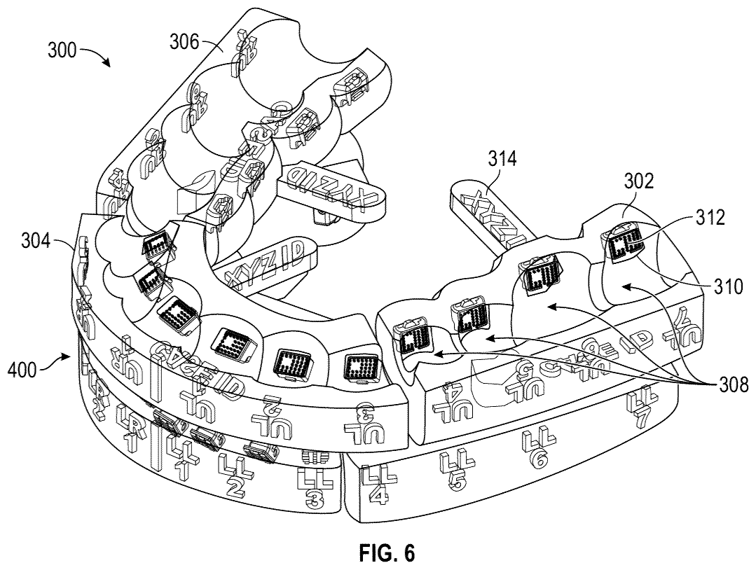

FIG. 6 illustrates upper indirect bonding trays 300 and lower indirect bonding trays 400. In some variants, the upper indirect bonding trays 300 may be a first color and the lower indirect bonding trays 400 may be a second color different than the first color to help differentiate trays for the upper and lower arches. The upper indirect bonding trays 300 can include a plurality of IDB trays (e.g., two, three, four, five, six, etc.) that can be positioned over segments of the upper dental arch of a patient. For example, the upper indirect bonding trays 300 can include a first IDB tray 302, second IDB tray 304, and/or third IDB tray 306. The first IDB tray 302 can include a plurality of cavities 308 to receive teeth of the patient. The cavities 308 can each include a well 310 to receive an orthodontic bracket 312 therein. While in the well 310, the orthodontic bracket 312 can have a bonding surface exposed, which may have an adhesive applied thereon prior to positioning the first IDB tray 302 over the teeth of the patient to facilitate bonding the orthodontic bracket 312 to a tooth of the patient. The first IDB tray 302 may include a tab 314, which may be a handle, to facilitate holding the first IDB tray 302 during handling. The tab 314 and/or other portions of the first IDB tray 302 may include information thereon. The second IDB tray 304 and/or third IDB tray 306 may include similar features as the first IDB tray 302. The lower indirect bonding trays 400 may include similar features as the upper indirect bonding trays 300.

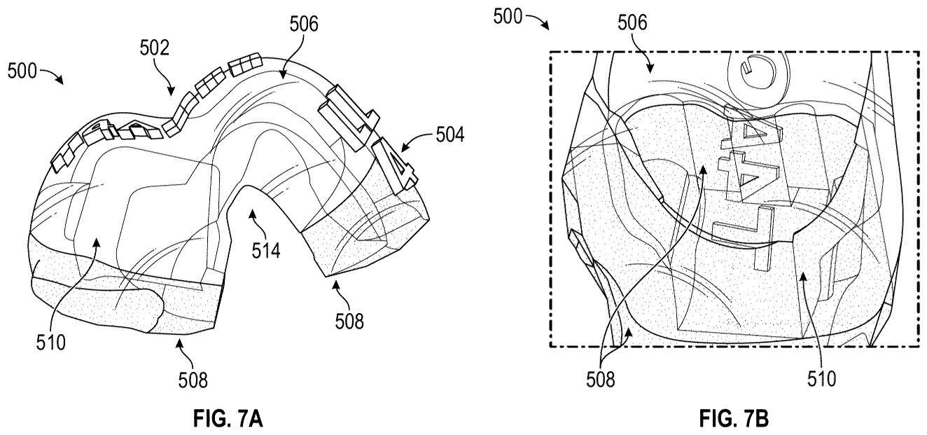

FIGS. 7A and 7B illustrate various views of an IDB tray 500. The IDB tray 500 may be configured to be seated over a single tooth of a patient, as arranged in FIGS. 7A and 7B, or the IDB tray 500 may be configured to be seated over a plurality of teeth of the patient, similar to as illustrated in FIG. 6. As described herein, configuring the IDB tray 500 to be seated on a single tooth can be advantageous. The single tooth IDB tray 500 can be used to precisely position an orthodontic bracket on a tooth of a patient without requiring specific relative positioning of adjacent teeth of the patient. Accordingly, the single tooth IDB tray 500 may be used to position an orthodontic bracket on a patient's tooth on the lingual or buccal side even after the patient's teeth have moved from an initial scanned configuration. The IDB tray 500 as described herein may be formed (e.g., 3D printed, overmolded on a physical model of the patient's teeth, etc.) based on a digital model of the patient's teeth and/or a digital IDB tray based on scans (e.g., 3D scans) of a patient's dental arch(es). The IDB tray 500 may be sized and/or shaped to be disposed over the crown(s) of one or more teeth. In some variants, the IDB tray 500 may extend to full crown on the labial side, which can allow more tooth registration surface.

The IDB tray 500 may include an occlusal portion 506, which may be a tray or shell, that sits on a patient's one or more teeth. The occlusal portion 506 may be disposed over the occlusal portions of a patient's one or more teeth. The occlusal portion 506 may include a rigid (e.g., stiff, hard, inflexible) material.

The IDB tray 500 may include a gingival portion 508, which may be disposed adjacent the gums with the IDB tray 500 seated on one or more teeth of the patient's teeth. The gingival portion 508 may gingivally extend from a gingival end of the occlusal portion 506, which can include positioning the gingival portion 508 between the occlusal portion 506 and the patient's gums with the IDB tray 500 disposed on one or more teeth of the patient. The gingival portion 508 may be disposed at a gingival periphery of the occlusal portion 506 and extend in the gingival direction. The gingival portion 508 may include a less rigid (e.g., soft, malleable, supple, flexible) material compared to the rigid material of the occlusal portion 506. In some variants, the gingival 1%, 5%, 10%, 15%, 20%, 25%, 30%, 35%, 40%, 45%, 50% or more or any value between any of the foregoing values of the IDB tray 500 may be the gingival portion 508. In some variants, the gingival portion 508 may extend from a gingival-most edge of the IDB tray 500 to a position that is 1%, 5%, 10%, 15%, 20%, 25%, 30%, 35%, 40%, 45%, 50% or more or any value between any of the foregoing values of the distance between the gingival-most edge and an occlusal-most point of the IDB tray 500. In some variants, the gingival portion 508 may extend more occlusally from the gingival-most edge of the IDB tray 500 on the labial side compared to the lingual side or on the lingual side compared to the labial side.

In some variants, the rigid material may allow for better registration with the tooth anatomy. The soft material (e.g., less rigid material) may allow for more flexibility when in contact with the patient's gums, which may improve patient comfort and/or accommodate for gum remodeling (e.g., reconfiguration, changes, etc.) during tooth movement from implementation of a treatment plan. For example, a scan of a patient's teeth in the initial maloccluded positions may be used to create the virtual model which is used to create the IDB tray 500, which may represent the patient's gums in an initial configuration. As the patient's teeth move during the course of a treatment plan, the patient's gums may change (e.g., remodel). Accordingly, an IDB tray designed based on the initial configuration of the patient's gums may be uncomfortable and/or not adequately register on a patient's tooth due to gum changes. Accordingly, the gingival portion 508 with the soft material may accommodate for these changes, which may increase comfort. The rigid material of the occlusal portion 506 may be a rigid photopolymer material. The soft material of the gingival portion 508 may be a soft photopolymer material, which may be less rigid than the rigid photopolymer material of the occlusal portion 506. The IDB tray 500 may be 3D printed with a 3D printer that may print using two or more materials (e.g., a rigid photopolymer material and a less rigid photopolymer material). Accordingly, the 3D printer may lay down layers of the rigid photopolymer material and soft photopolymer material to form the IDB tray 500. The rigid material may be more rigid than the soft material. In some variants, the rigid material of the occlusal portion 506 may be a first color (e.g., teal or any other color) and the soft material of the gingival portion 508 may be a second color (e.g., purple or any other color) different than the first color. In some variants, the rigid material of the occlusal portion 506 and the soft material of the gingival portion 508 may be the same color. In some variants, the rigid material of the occlusal portion 506 and the soft material of the gingival portion 508 may be transparent (e.g., clear).

The rigid photopolymer material may have a tensile strength of 40-65 MPa. In some variants, the rigid photopolymer material may have a tensile strength of less than 30 MPa, 30 MPa, 35 MPa, 40 MPa, 45 MPa, 50 MPa, 55 MPa, 60 MPa, 65 MPa, 70 MPa, 75 MPa, 80 MPa, or more than 80 MPa or any value between any of the foregoing values. The rigid photopolymer may have a percent elongation of 10-25%. In some variants, the rigid photopolymer may have a percent elongation of less than 5%, 5%, 10%, 15%, 20%, 25%, 30%, 35%, 40%, or more than 40% or any value between any of the foregoing values. The rigid photopolymer material may have a Shore D hardness of 83-86. In some variants, the rigid photopolymer material may have a Shore D hardness of less than 75, 75, 76, 77, 78, 79, 80, 81, 82, 83, 84, 85, 86, 87, 88, 89, 90, or more than 90.

The soft photopolymer material may have a tensile strength of 3-5 MPa. In some variants, the soft photopolymer material may have a tensile strength of less than 1 MPa, 1 MPa, 2 MPa, 3 MPa, 4 MPa, 5 MPa, 6 MPa, 7 MPa, 8 MPa, 9 MPa, 10 MPa, or more than 10 MPa or any value between any of the foregoing values. The soft photopolymer may have a percent elongation of 45-55%. In some variants, the soft photopolymer may have a percent elongation of less than 30%, 35%, 40%, 45%, 50%, 55%, 60%, 65%, 70%, or more than 70% or any value between any of the foregoing values. The soft photopolymer material may have a Shore A hardness of 73-77. In some variants, the soft photopolymer material may have a Shore A hardness of less than 65, 65, 66, 67, 68, 69, 70, 71, 72, 73, 74, 75, 76, 77, 78, 79, 80, or more than 80.

The IDB tray 500 may include a cavity 514 to receive a tooth of the patient therein. The occlusal portion of the cavity 514 may be primarily defined by the occlusal portion 506 and the gingival portion of the cavity 514 may be primarily defined by the gingival portion 508. The cavity 514 can be custom configured based on a specific tooth of the patient. For example, the cavity 514 can be sized and shaped to receive the specific tooth of the patient therein. The periphery defining the cavity 514 can include contours based on the specific tooth of the patient.

The IDB tray 500 may include a well 510 (e.g., pocket, receptacle, cavity, holder, etc.) to hold an orthodontic bracket therein. The well 510 may be open to the cavity 514. The well 510 may be positioned on the IDB tray 500 based on the positioning of a digital bracket on a digital tooth in a virtual model of the patient's tooth. The well 510 may be configured to receive an orthodontic bracket corresponding to the digital bracket. For example, the well 510 may be configured (e.g., sized, shaped, etc.) to receive an orthodontic bracket therein that corresponds to the configuration of a digital orthodontic bracket selected and/or designed in the virtual model of the patient's teeth. When the orthodontic bracket is disposed in the well 510, a bonding surface of the orthodontic bracket may be exposed on which adhesive may be applied. An inner periphery of the IDB tray 500 defining the well 510 may include a soft material, which may be the same soft material (e.g., soft photopolymer) as the gingival portion 508. The periphery of the well 510 may be encased (e.g., surrounded, coated) with the soft material, which may facilitate insertion (e.g., loading) and release (e.g., removal) of an orthodontic bracket from the well 510. The well 510 may be formed in the occlusal portion 506. The well 510 may be formed in the gingival portion 508. The well 510 may be formed in the occlusal portion 506 and the gingival portion 508. The well 510 or portion thereof formed in the occlusal portion 506 may be lined (e.g., coated, surrounded, encased) by the soft material. The soft material of the well 510 may enable the orthodontic bracket to be better retained by the well 510 compared to a well 510 without the soft material. For example, the soft material may flex to receive the orthodontic bracket within the well 510. The soft material may better enable the orthodontic bracket to be released from the well 510 compared to a well 510 without the soft material. For example, the soft material may flex as the IDB tray 500 is lifted off a patient's tooth, which may reduce the likelihood that the orthodontic bracket will catch on a periphery of the well 510 and inhibit removal of the IDB tray 500. Similarly, the orthodontic bracket may be more easily removed from the well 510 due to the flexing of the soft material.

The IDB tray 500 may include case identification indicia 502. The case identification indicia 502 may be disposed on an occlusal side of the IDB tray 500. The case identification indicia 502 may include a case identification number associated with the IDB tray 500, which may help identify the IDB tray 500 and/or associate the IDB tray 500 with a patient. The case identification indicia 502 may include alphanumeric features (e.g., markings, indications, signs, etc.). In some variants, the case identification indicia 502 may include a computer readable code (e.g., bar code, QR code, etc.). The case identification indicia 502 may be printed by the 3D printer, which may be printed with the rigid material, soft material, and/or a third material. The case identification indicia 502 may include a color that is the same as one or both of the rigid material and soft material. The case identification indicia 502 may be a color that is different than the rigid material and soft material. The case identification indicia 502 may be disposed in the IDB tray 500 (e.g., occlusal portion 506) and/or on a surface of the IDB tray 500 (e.g., occlusal portion 506).

The IDB tray 500 may include tooth identification indicia 504. The tooth identification indicia 504 may be disposed on a labial side of the IDB tray 500. The tooth identification indicia 504 may include alphanumeric features (e.g., markings, indications, signs, etc.), which may help correspond the IDB tray 500 with a specific tooth of the patient. In some variants, the tooth identification indicia 504 may include a computer readable code (e.g., bar code, QR code, etc.). The tooth identification indicia 504 may be printed by the 3D printer, which may be printed with the rigid material, soft material, and/or a third material. The tooth identification indicia 504 may include a color that is the same as one or more of the rigid material, soft material, and/or case identification indicia 502. The tooth identification indicia 504 may be a color that is different than one or more of the rigid material, soft material, and/or case identification indicia 502. The tooth identification indicia 504 may be disposed in the IDB tray 500 (e.g., occlusal portion 506 and/or gingival portion 508) and/or on a surface of the IDB tray 500 (e.g., occlusal portion 506 and/or gingival portion 508).

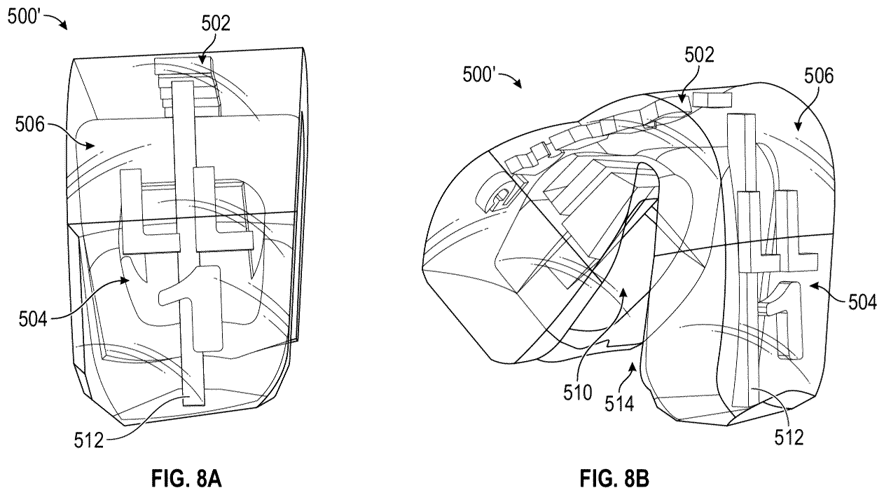

FIGS. 8A and 8B illustrate another IDB tray 500′, which may include any of the features disclosed in reference to other IDB trays described herein. For illustrative purposes, the IDB tray 500′ is shown without the gingival portion with the soft material and the soft material disposed at the well 510, but as described herein, the IDB tray 500′ may include these features. The tooth identification indicia 504 of the IDB tray 500′ may include “LL 1”, as illustrated, to indicate a tooth that corresponds with the IDB tray 500′. The IDB tray 500′ may include an orientation indicia 512 to help indicate to a user whether the IDB tray 500 is properly seated on the patient's tooth to place and bond an orthodontic bracket. The orientation indicia 512 can include a line. The line 512 may be oriented such that the longitudinal length extends in the occlusal-gingival direction. The line 512 may enable a user to visually see if the IDB tray 500′ is improperly seated (e.g., registered) on a patient's tooth. For example, the line 512 may be configured to be disposed along a midline of the tooth. The line 512 may be angled off the midline of the tooth to indicate that the IDB tray 500′ is improperly seated on the tooth. The orientation indicia 512 may be disposed on the labial side or the lingual side of the IDB tray 500′. The orientation indicia 512 may be the same color as other features described herein. The orientation indicia 512 may be a different color than the other features described herein. The orientation indicia 512 may be printed as part of the IDB tray 500′, which may include being printed with the rigid material, soft material, and/or another material. The orientation indicia 512 may be disposed in the IDB tray 500 (e.g., occlusal portion 506) and/or on a surface of the IDB tray 500 (e.g., occlusal portion 506).

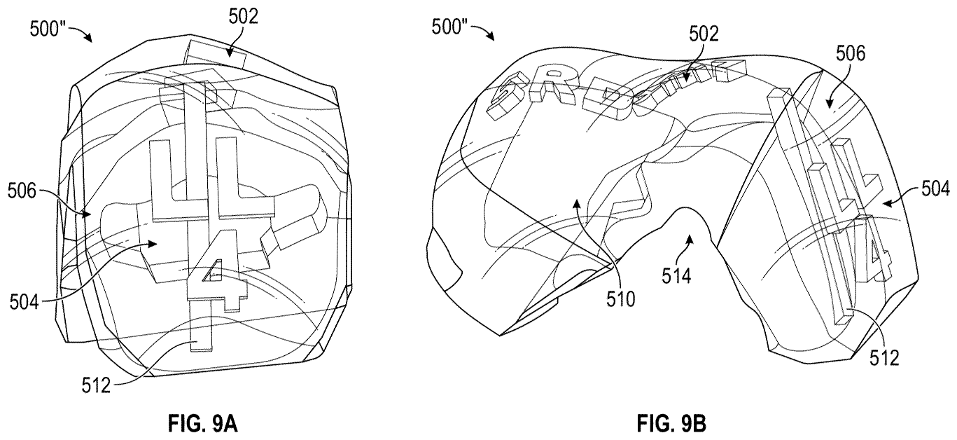

FIGS. 9A and 9B illustrate another IDB tray 500″, which may include any of the features disclosed in reference to other IDB trays described herein. For illustrative purposes, the IDB tray 500″ is shown without the gingival portion with the soft material and the soft material disposed at the well 510, but as described herein, the IDB tray 500″ may include these features. The IDB tray 500″ may be configured for a molar or pre-molar. The IDB tray 500′ may be configured for incisors and/or canines.

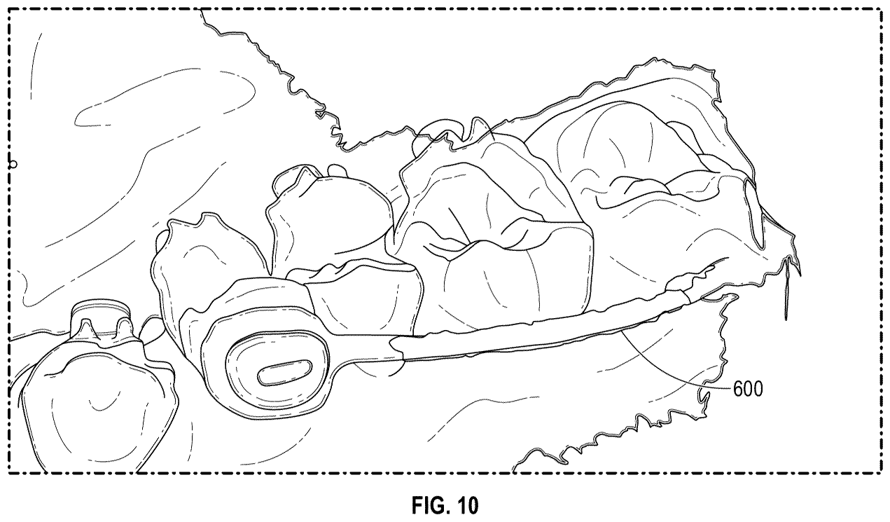

FIG. 10 illustrates a labial auxiliary appliance 600, which may be a motion appliance. The labial auxiliary appliance 600 may be positioned on the labial side of a patient's teeth to move the teeth. In some variants, one or more of the IDB trays 500, 500′, and/or 500″ can include a gingival portion 508 with the soft material on the labial side that extends more occlusally from a gingival-most edge of the IDB tray to allow for a clinician to cut the soft material off, at least partially, to provide room for the labial auxiliary appliance 600. In some variants, the gingival 10%, 15%, 20%, 25%, 30%, 35%, 40%, 45%, 50%, 55%, 60%, 65%, 70% or more or any value between any of the foregoing values of the labial sides of the IDB trays 500, 500′, and/or 500″ may include the gingival portion 508 with the soft material. For example, the gingival portion may extend from a gingival-most edge of the IDB tray to a position that is 10%, 15%, 20%, 25%, 30%, 35%, 40%, 45%, 50%, 55%, 60%, 65%, 70% or more or any value between any of the foregoing values of the distance between the gingival-most edge and an occlusal-most point of the IDB tray. In some variants, the gingival portion may extend more occlusally on the labial side of the IDB tray compared to the lingual side.

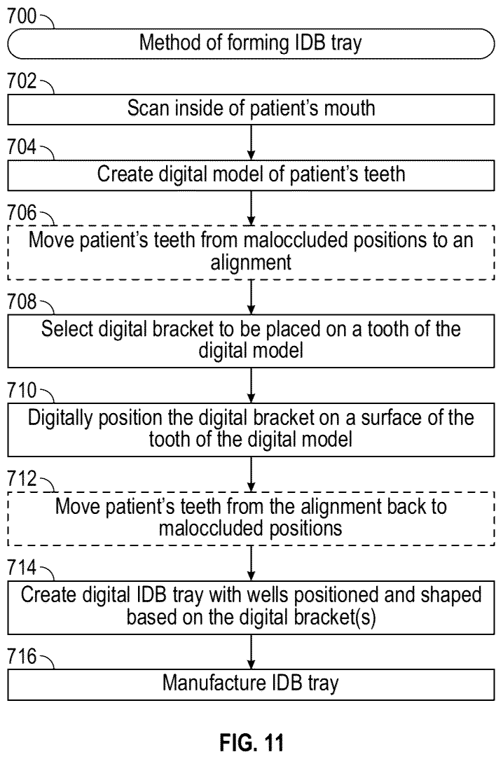

FIG. 11 illustrates an example method 700 of forming an IDB tray, which may include the features of any of the IDB trays disclosed herein. This flow diagram is provided for the purpose of facilitating description of aspects of some embodiments. The diagram does not attempt to illustrate all aspects of the disclosure and should not be considered limiting.

At block 702, a scan (e.g., 3D scans and/or 2D scans) can be taken of the inside of the patient's mouth (e.g., dental arches). The scan can capture data regarding the type, size, shape, contours, surface features, positioning, and/or other characteristics of the patient's teeth. The scans can be taken by the patient, caretaker of the patient, and/or clinician. The scan can be performed using a camera and/or sensor of a computing device (e.g., computer, laptop, tablet, smartphone, mobile device, etc.) or device connected to a computing device. In some variants, an application can be used to perform the scans-providing the patient with instructions on how to perform the scan and when a scan is successful. The scan can be performed using the mobile device's built-in camera or via an attachment that operatively connects to the mobile device or computing device. The scanned data can be sent to a manufacturer of orthodontic appliances for processing and/or use.

At block 704, a digital model of the patient's teeth can be created based on scans of the inside of the patient's mouth. The digital model can represent the unique size, shape, contours, surface features, positioning, and/or other characteristics of the patient's teeth. The digital model can be displayed to an operator for viewing and/or manipulation. In some variants, the digital model can be automatically generated by software implemented on a computing device using the scans of the inside of the patient's mouth. The digital teeth may be sectioned from each other to facilitate relative movement.

At block 706, the patient's teeth in the digital model can be moved from the first positions (e.g., maloccluded positions, scanned positions) to an alignment (e.g., final alignment, second positions). In some variants, an operator can manually move the patient's teeth in the digital model. In some variants, a software program implemented on a computing device can automatically move the patient's teeth in the digital model to the alignment. In some variants, the software program may move the patient's teeth to an alignment and the operator may adjust the alignment. In some variants, the method 700 may skip block 706.

At block 708, a digital bracket suitable for bonding on a surface of a tooth can be selected from a variety of digital brackets. Certain types and/or sizes of brackets may be more suitable and/or preferred for bonding on a given tooth but not others. For example, a bracket with lateral extensions may be suitable for bonding on the molars but not on the lower incisors because of differences in size and shape. In some variants, an operator can select a digital bracket from a variety of digital brackets for placement on a tooth based on the type of tooth and/or features of the tooth shown in the digital model. In some variants, software implemented on a computing device may suggest one or more digital brackets from a variety of digital brackets for placement on a tooth based on the type of tooth and/or features of the relevant tooth. In some variants, software implemented on a computing device may select a digital bracket from a variety of digital brackets based on the type of tooth and/or features of the relevant tooth. In some variants, the operator may design a custom digital bracket for a digital tooth, which may at least include any of the features of any of the brackets described herein.

At block 710, the digital bracket can be digitally placed on the surface of the relevant digital tooth of the digital model. In some variants, the operator can place the selected digital bracket on the surface (e.g., lingual or buccal surface) of the digital tooth in the digital model. In some variants, the digital bracket can be automatically placed by a software program on the surface of the digital tooth in the digital model. The processes described in reference to block 708 and block 710 can be repeated to select and respectively place a plurality of digital orthodontic brackets on surfaces of the digital teeth in the digital model, which can include every tooth of the digital model or only some (e.g., one, two, three, etc.) of the teeth of the digital model.

At block 712, the digital teeth in the digital model can be moved from the alignment back to the first positions with the digital brackets positioned on the digital teeth, which can help to confirm that no collisions will occur during movement of the teeth. In some variants, the digital brackets may be positioned on the digital teeth prior to moving the digital teeth from the first positions to the alignment and back to the first positions. In some variants, the digital teeth may not be moved, skipping blocks 706 and 712, when forming the IDB tray.

At block 714, a digital IDB tray can be created with well(s) positioned and shaped based on the digital bracket(s) positioning on the one or more digital teeth in the first position(s) in the digital model. In some variants, the digital IDB tray can be created in the digital model. The digital IDB tray can be configured for placing bracket(s) on one or more digital teeth in the digital model. As detailed herein, a digital IDB tray configured for placing a bracket on a single tooth can be advantageous, especially when placing an orthodontic bracket on a tooth after a patient's teeth have moved from first positions (e.g., scanned positions). In some variants, a digital IDB tray can be configured for placing a plurality of orthodontic brackets on a plurality of teeth, which can be advantageous for efficiently placing a plurality of orthodontic brackets prior to a patient's teeth moving from the first positions.

In some variants, an operator can manually create the digital IDB tray based on the digital teeth in the first positions with the digital bracket(s) placed. In some variants, a software program implemented on a computing device can automatically create the digital IDB tray based on the digital teeth in the first positions with the digital brackets placed. In some variants, a software program implemented on a computing device can automatically create the digital IDB tray to extend from proximate surfaces of the digital teeth and digital brackets to an outer periphery. The digital IDB tray can include any of the features described in reference to any of the IDB trays disclosed herein. The digital IDB tray can be sized to sit over a single tooth, more than one tooth, and/or an entire dental arch. The case identification indicia 502, tooth identification indicia 504, and/or orientation indicia 512, as disclosed herein, can be added to the digital IDB tray, which can include being added automatically by a software program implemented by a computing device and/or manually by an operator. The case identification indicia 502, tooth identification indicia 504, and/or orientation indicia 512 may be disposed inside the digital IDB tray and/or at a surface thereof. In some variants, the color and/or material of the case identification indicia 502, tooth identification indicia 504, and/or orientation indicia 512 may be selected. The portions of the digital IDB tray including the rigid material and/or soft material may be specified, which can include being specified automatically by a software program implemented by a computing device and/or manually by an operator. For example, as described herein, the portion(s) of the IDB tray bounding the well(s) may include the soft material. The gingival portion(s) of the IDB tray may include the soft material, which may increase comfort and/or compatibility with a patient's gums. In some variants, the configuration of the occlusal portion 506 and/or the gingival portion 508 may be adjusted. For example, the gingival portion 508 may be configured to extend more occlusally or less occlusally. The thickness of the IDB tray may be adjusted.

At block 716, an IDB tray may be manufactured based on the digital IDB tray and include any of the features of the IDB trays disclosed herein. The IDB tray may be manufactured using one or more techniques, which may at least include 3D printing, over molding, machining, and/or other methods. For example, a 3D printer capable of printing in two or more materials (e.g., the rigid material and soft material) may print the IDB tray.

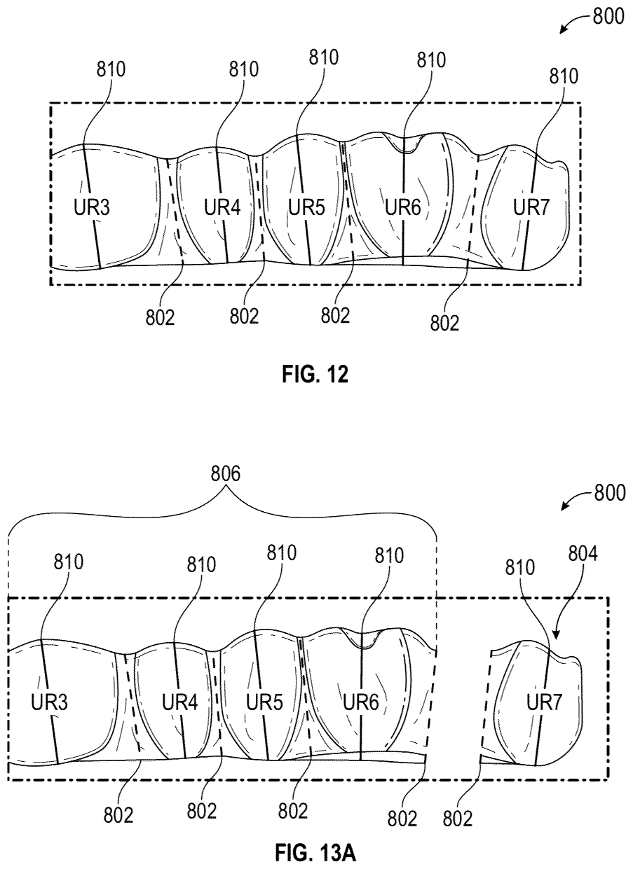

As illustrated in FIG. 12, an indirect bonding (IDB) tray 800 can include separation indicia(s) 802 (e.g., separation line indicia, separation lines, cut lines) to visually indicate to an operator where to cut (e.g., section, separate, tear) the IDB tray 800. The IDB tray 800 can include alignment indicia 810 (e.g., long axis marking, long axis alignment mark, alignment mark, lines, alignment lines), which can visually indicate to an operator if the IDB tray 800 or a portion thereof is properly positioned on a patient's one or more teeth. The alignment indicia 810 can include any of the features described herein for orientation indicia 512 and be used in similar manners.

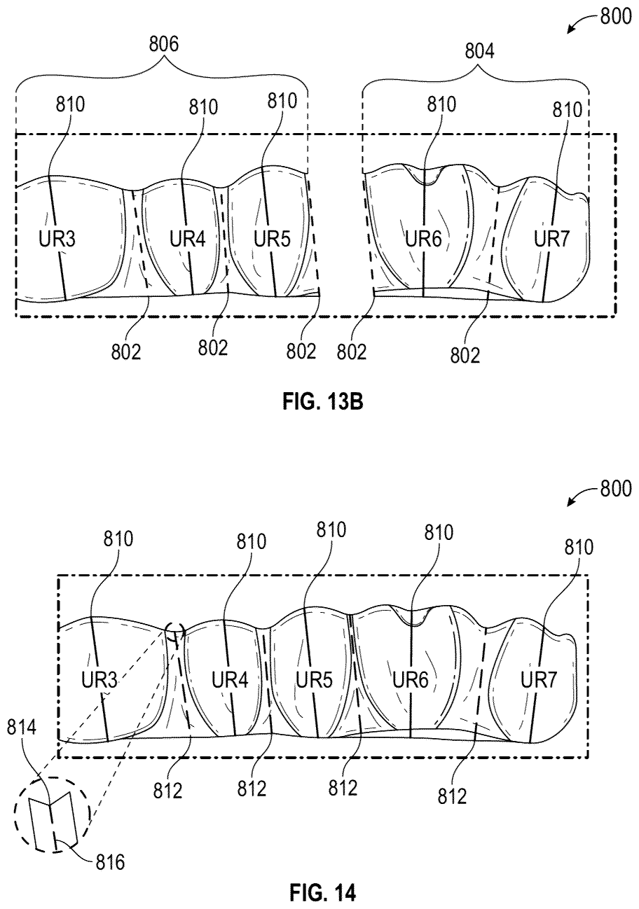

The separation indicia(s) 802 can be present between each section (e.g., cavity, pocket) of the IDB tray 800 that houses an individual tooth of a patient, such that the IDB tray 800 can be cut or otherwise separated along any of the separation indicia(s) 802 to separate the IDB tray 800 into an IDB tray portion 804 and an IDB tray remainder 806 as shown in FIG. 13A. The IDB tray remainder 806 can be cut or otherwise separated along separation indicia(s) 802 into smaller portions. This process can be repeated until there is an IDB tray portion 804 corresponding with each and every tooth of the patient. In some variants, the IDB tray 800 can include separation indicia 802 between some but not all of the sections that house individual teeth of the patient. As illustrated in FIG. 13A, an operator can separate the IDB tray 800 along a separation indicia 802 to create an IDB tray portion 804 to be seated on a single tooth of the patient and an IDB tray remainder 806 to be seated on a plurality (e.g., four) of teeth of the patient. Alternatively, an operator can separate the IDB tray 800 along a separation indicia 802 to create a portion and a remainder each sized to be seated on a plurality of teeth of the patient. As illustrated in FIG. 13B, the IDB tray 800 can be sectioned along a separation indicia 802 to create an IDB tray portion 804 suitable for placing over only two teeth of the patient, with the corresponding IDB tray remainder 806 having one less tooth section (e.g., pocket, cavity) compared to FIG. 13A such that the remainder 806 is sized to be seated on three teeth of the patient as opposed to four.

The separation indicia 802 can take many forms, such as indicia (e.g., lines) printed on an outer surface of the IDB tray 800, perforations formed in the IDB tray 800 to ease sectioning by hand, voids formed during the printing process for the IDB tray 800, indicia within the shell of the IDB tray 800 (e.g., indicia between an inner surface and an outer surface), indicia printed on an inner surface of the IDB tray 800, indicia(s) with a different material composition in relation to adjacent tooth sections to facilitate cutting, breaking, and/or other methods of separating. An IDB tray portion 804 can be used to attach orthodontic brackets, auxiliaries, bite turbos, etc. onto one tooth or a plurality of teeth.

The separation indicia 802 may take the form of lines printed on the IDB tray 800. These lines can be printed by depositing 3D printing material onto the outermost layer of the IDB tray 800 to indicate where the IDB tray 800 can be cut (e.g., separated, sectioned) by an operator. The separation indicia 802 can be disposed along the innermost surface of the IDB tray 800. The separation indicia 802 can be disposed along the innermost surface and the outermost surface of the IDB tray 800. The separation indicia 802 can be disposed between the inner and outermost surfaces of the IDB tray 800, which can include between and on the inner and outermost surfaces. The separation indicia 802 can be a variety of colors and/or widths. The separation indicia 802 can follow the contours of the IDB tray 800 to extend between buccal and lingual edges of the IDB tray 800. The indications (e.g., tooth indications, patient information, etc.) can be colored similarly to the separation indicia 802. The separation indicia 802 and/or indications may be printed in a material with a different opacity compared to the tooth cavity sections of the IDB tray 800. The separation indicia(s) 802 can be printed below the surface level of the outermost surface of the IDB tray 800. The separation indicia 802 can be solid lines, dashed lines, dash-dot lines, dotted lines, dots, dashes, marks, etc.

The separation indicia(s) 802 can include perforations and/or other features to facilitate sectioning the IDB tray 800 by hand. The perforations can be orientated to facilitate separating the IDB tray 800 into an IDB tray portion 804 and an IDB tray remainder 806.

The separation indicia 802 may take the form of voids formed during or after the printing process of the IDB tray 800. These voids can be formed in various ways, such as by configuring the 3D printer to form these voids and/or by configuring an apparatus to form these perforations into the fully printed IDB tray 800. The apparatus can take the form of a press that passes members (e.g., hollows members) into a solid IDB tray 800 to form the perforations of the separation indicia 802. The apparatus can also take the form of pressing a heating element into the IDB tray 800 to form the separation indicia 802 of voids or perforations via melting. The apparatus can take the form of any other method that can generate holes along the separation indicia 802 to indicate to the operator where to cut or section the IDB tray 800 and/or to ease cutting or sectioning the IDB tray 800.

The separation indicia 802 may include a more rigid material than the material immediately surrounding the separation indicia 802 and can have features to facilitate snapping the IDB tray 800 into an IDB tray portion 804 and IDB tray remainder 806. FIG. 14 depicts an IDB tray 800 with snap indicia 812. The snap indicia 812 can be positioned at the locations described for the separation indicia 802. The snap indicia 812 can have features which decrease the force to snap the IDB tray 800 to form an IDB tray portion 804 and IDB tray remainder 806. One of these features can be a snap divot 814 located along the snap indicia 812, where the cross-sectional area may be smallest. By having the material be thinner in these areas, the snap divot 814 can decrease the force needed to separate one section of the IDB tray 800, and localize the division of the two adjoining members. Another optional feature can be a weakened bonding area 816, which can be formed with printing techniques while fabricating the IDB tray 800 such that one half or a portion of the snap indicia 812 is weakly connected to the other half or remaining portion of the snap indicia 812. The weakened bonding area 816 can be formed by a variety of 3D printing techniques (e.g., sequential printing of one half or a portion of the snap indicia 812, waiting for that half or portion to cool substantially, then returning to cool the remaining half or remaining portion of the snap indicia 812, so that the halves or portions are bonded but not printed within the same pass by the 3D printer). The snap indicia 812 can have structural integrity, which can include being fixedly adhered to the IDB tray 800.

Separation of the IDB tray portion 804 from the IDB tray remainder 806 along a separation indicia 802 may be assisted by a cutting feature (e.g., wire, string, cutting edge) fixedly attached to a fixture (e.g., member) incorporated into the IDB tray. The cutting feature can protrude from the IDB tray and be grasped by a clinician. The clinician can grasp the cutting feature and maneuver it along the separation indicia (e.g., move, such as rotate, the cutting feature around the fixture) to section the IDB tray.

The IDB trays described herein may include any of the features described in and/or be manufactured using similar techniques to those described in U.S. patent application Ser. No. 17/084,383, filed Oct. 29, 2020, now published as U.S. Publication No. 2021/0128275, the entirety of which is hereby incorporated by reference herein.

It is intended that the scope of this present invention herein disclosed should not be limited by the particular disclosed embodiments described above. This invention is susceptible to various modifications and alternative forms, and specific examples have been shown in the drawings and are herein described in detail. This invention is not limited to the detailed forms or methods disclosed, but rather covers all equivalents, modifications, and alternatives falling within the scope and spirit of the various embodiments described and the appended claims. Various features of the orthodontic brackets and archforms described herein can be combined to form further embodiments, which are part of this disclosure.

Methods of using the orthodontic brackets and/or archforms (including device(s), apparatus(es), assembly(ies), structure(s) or the like) are included herein; the methods of use can include using or assembling any one or more of the features disclosed herein to achieve functions and/or features of the system(s) as discussed in this disclosure. Methods of manufacturing the foregoing system(s) are included; the methods of manufacture can include providing, making, connecting, assembling, and/or installing any one or more of the features of the system(s) disclosed herein to achieve functions and/or features of the system(s) as discussed in this disclosure.

Various other modifications, adaptations, and alternative designs are of course possible in light of the above teachings. Therefore, it should be understood at this time that within the scope of the appended claims the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “tying a tie onto an orthodontic bracket” includes “instructing the tying of a tie onto an orthodontic bracket.” The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

1. An indirect bonding (IDB) tray configured to be seated on a single tooth of a patient to position a single orthodontic bracket on the single tooth, the IDB tray comprising:
an occlusal portion comprising a first material;
a gingival portion disposed on and extending gingivally from a gingival end of the occlusal portion, the gingival portion configured to be disposed proximate gums of the patient and comprising a second material; and
a well configured to receive the single orthodontic bracket therein;
wherein the IDB tray is configured to be seated on the single tooth of the patient irrespective of a relative positioning of the single tooth with respect to other teeth of the patient.

2. The IDB tray of claim 1, the well comprising a periphery that includes the second material.

3. The IDB tray of claim 1, wherein the first material and the second material are photopolymers.

4. The IDB tray of claim 1, wherein the first material is a rigid photopolymer.

5. The IDB tray of claim 4, wherein the second material is a flexible photopolymer.

6. The IDB tray of claim 1, wherein the first material comprises a first color and the second material comprises a second color that is different than the first color.

7. The IDB tray of claim 1, wherein the first material and the second material are transparent.

8-18. (canceled)

19. The IDB tray of claim 1, further comprising an orientation indicia configured to indicate if the IDB tray is properly seated on the single tooth to position the single orthodontic bracket.

20. The IDB tray of claim 19, wherein the orientation indicia comprises a line oriented such that a longitudinal length thereof extends in an occlusal-gingival direction.

21. The IDB tray of claim 19, wherein the orientation indicia is disposed within the IDB tray.

22. The IDB tray of claim 19, wherein the orientation indicia is disposed on a surface of the IDB tray.

23. The IDB tray of claim 1, wherein the gingival portion extends from a gingival-most edge of the IDB tray to a position that is 5% of a distance between the gingival-most edge and an occlusal-most point of the IDB tray.

24-27. (canceled)

28. An indirect bonding (IDB) tray configured to be seated on a plurality of teeth of a patient to position a plurality of orthodontic brackets, the IDB tray comprising:
an occlusal portion comprising a first material;
a gingival portion extending gingivally from a gingival end of the occlusal portion, the gingival portion configured to be disposed proximate gums of the patient and comprising a second material; and
a plurality of wells configured to receive the plurality of orthodontic brackets therein.

29-111. (canceled)

112. The IDB tray of claim 1, wherein the first material is more rigid than the second material.

113. The IDB tray of claim 1, wherein the first material comprises a tensile strength that is greater than a tensile strength of the second material.

114. The IDB tray of claim 113, wherein the first material comprises a tensile strength of 50-65 MPa.

115. The IDB tray of claim 114, wherein the second material comprises a tensile strength of 3-5 MPa.

116. The IDB tray of claim 1, wherein the first material is less flexible than the second material.

117. The IDB tray of claim 1, wherein the first material comprises a percent elongation that is less than a percent elongation of the second material.

118. The IDB tray of claim 1, wherein the first material comprises a percent elongation of 10-25%.

119. The IDB tray of claim 1, wherein the second material comprises a percent elongation of 45-55%.

120. The IDB tray of claim 1, wherein the first material comprises a hardness that is greater than a hardness of the second material.

121. The IDB tray of claim 120, wherein the first material comprises a Shore D hardness of 83-86.

122. The IDB tray of claim 121, wherein the second material comprises a Shore A hardness of 73-77.

123-164. (canceled)

165. The IDB tray of claim 28, further comprising a plurality of separation indicia indicating where to separate the IDB tray.

166. (canceled)

167. (canceled)
